(19) United States
(12) Patent Application Publication
(10) Pub. No.: US 2012/0041128 A1
(43) Pub. Date: Feb. 16, 2012

(54) HIGHLY DISPERSIBLE SILICA FOR RUBBERS AND THE PROCESS FOR OBTAINING IT

(75) Inventor: Raisa Avgustovna Kosso, Moscow (RU)

(73) Assignee: Dimona Silica Industries, Dimona (IL)

(21) Appl. No.: 12/998,278

(22) PCT Filed: Oct. 11, 2009
(86) PCT No.: PCT/IL2009/000956

§ 371 Date: Nov. 3, 2011

(30) Foreign Application Priority Data
Oct. 6, 2008 (GB) 0818240.4

(51) Int. Cl. C08K 3/36; C01B 33/12; C08L 9/00; C01B 33/193; B01J 19/00; C08L 9/06

(52) U.S. Cl. 524/493; 422/129; 422/105; 524/575; 524/571; 423/339; 423/335; 428/219

(57) ABSTRACT

The present invention relates to a precipitated silica for elastomers and, more particularly, to a new highly dispersible and highly reinforcing precipitated silica for elastomers. The invention further provides the process for its production and rubber products made therefrom.

In the rubber industry, fillers are used to enhance the reinforcement properties of the rubber. Obtaining optimal reinforcing properties requires that the particles of the filler will be both finely divided and homogeneously distributed within the rubber matrix. These conditions can only be satisfied if these particles are easily incorporated into the rubber matrix during the initial mixing with the elastomer while avoiding agglomeration, and thereafter break down to a very fine aggregates and agglomerates, which can disperse perfectly and homogeneously in the elastomer.

Precipitated silica has long been used as a white reinforcing filler for elastomers, in particular for tires. However, silica particles have an annoying tendency to agglomerate among themselves, forming a filler network in the elastomer matrix because of mutual attraction. These silica-silica interactions limit the reinforcing properties to a level that is far lower than that which could theoretically be achieved between the silica and the elastomer during mixing. Furthermore, the silica-silica interactions also tend to increase the rigidity and consistency of the mixture in the uncured state, making its use more difficult.

Starting from the 1990′s, a new category of silica has been developed, holding better dispersion qualities inside the elastomer, this silica being termed “high dispersion silica” or highly-dispersible silica (HDS or HD Silica).

Since HD silica is used for the reinforcement of elastomers, the evaluation of its dispersion rate with the elastomers is of importance for the manufacturers and users thereof, resulting in a number of methods which have been developed over the years for obtaining this evaluation and classifying the silica.

For example, U.S. Pat. Nos. 5,403,570 5,547,502, 5,587,416, 6,335,396 and 6,001,322 disclose HD silica defined by its average particle diameter (D₅₀) after ultrasound treatment and by the ultrasound disagglomeration factor (FD), such that the lower the D₅₀ and the higher the FD, the higher level of dispersion of silica which is obtained.

U.S. Pat. No. 6,180,076; European Patent No. 0983966 and U.S. Patent Applications 20050187334 and 20060137575, 20070100057 disclose HD silica defined by the ratio of the peak heights of primary silica particles (1-100 μm) to degraded particles (≦1 μm)μm after ultrasound treatment, termed the Wk coefficient. In HDS, this coefficient must not exceed a level of 3.4 and the lower the value, the higher is the silica dispersion level.

In yet additional examples, U.S. Pat. Nos. 5,227,425; 5,665,812; 5,900,449; 6,013,718 and 7,300,970, and European Patent No. 0501227, disclose HD silica defined by the particles' speed of disagglomeration under ultrasound treatment. The more rapid this process is, the higher silica dispersion in elastomers is obtained.

Another measure of the silica structure is achieved by considering the rate of aggregation or agglomeration. The higher this rate, the more pores there are in the structure and the more “developed” it is considered. Under pressure, the structure is destroyed (90% and more for HD silica and up to 80-90% for conventional silica). The unit used to express the size of the structure is the di-butyl phthalate (DBP) absorption coefficient, reflecting the volume of voids in the structure. The DBP coefficient is measured by the ASTM D-2414 standard test, developed originally for the characterization of carbon black. Silicas with DBP absorption values of up to 380 g/100 g are known as described in EP 0 078 909 and in U.S. Pat. No. 5,859,117, both by Degussa.

Since it is known that during the manufacturing of rubber mixes the destruction of the filler structure takes place at the account of the shift stresses action, Kraus (Rubber Chem. Technol., 46, 422, 1973) has suggested using another characterizing coefficient termed CDBP absorption (compressed DBP), which is similar to the DBP absorption coefficient, except that the sample is compressed before the oil absorption measurement. For carbon black, the structural damage takes place under 165 MPa. The CDBP absorption is determined according to the ASTM D-3493 standard method.

Both the DBP absorption and the CDBP absorption numbers correlate with the reinforcing interagglomerate structure of the silica, which is important for the incorporation and dispersion of the silica within the rubber.

Precipitated Silica is usually prepared by a chemical reaction between an alkali silicate, such as sodium silicate (also termed water glass or liquid glass), and an acid (R. K. Her, Chemistry of Silica, John Wiley & Sons, 1979). In many cases the acid is a sulfuric acid, and therefore one of the byproducts of this process is sodium sulfate, which must be washed out. The chemical reaction is an equilibrium, and is strongly influenced by process parameters, such as pH, temperature, concentrations and speed of components introduction.

During the precipitation process, four main stages can be distinguished, reflecting the gradual growth of the precipitated silica: in the very beginning, small isolated particles, called primary particles, are formed (nucleation or seeding stage). The concentration of these nucleus particles in the beginning of carbonization process is usually low, they are far away from each other and the particle size is in the range of a few nanometers.

As the reaction proceeds, the amount and size of these particles increases and when the concentration is sufficiently high and the particles are close enough together (flocculation stage), a reaction between the primary particles can occur, thereby forming Si—O—Si bonds between primary particles and resulting in larger particles called “aggregates” (aggregation stage). The still ongoing process results in a continuous growth of the number and size of the aggregates. If the concentration reaches a certain limit, the aggregates are close enough for the formation of greater units, called agglomerates (agglomeration stage). The obtained agglomerated silica is filtered and washed to obtain a filtered cake, which is then dried and optionally granulated to produce the precipitated silica.

The properties of the obtained silica are largely dependant on the conditions of this general process, for example, the pH, temperature, the drying parameters (type of dryer, drying temperature, solid content and time) and the granulation parameters (feed rate and granulation pressure). Therefore, it is clear that even small modifications in the process parameters can result in major changes in the silica product properties and in the subsequent rubber behavior.

It is important to note that in presently-known processes the precipitation stage is conducted at a constant pH level. Furthermore, the addition of the liquid-glass is conducted at a constant speed, or by amending the speed only after periods of so-called “aging” (resting) of the suspension.

The development of highly dispersible silica has allowed substantial improving of the strength and operational properties of rubbers with increased content of silica, which in turn lead to the expansion of silica usage to other application, such as in preparing truck tires.

Nevertheless, the further enhancement of silica reinforcing properties remains a challenge for the tire industry, which has ever-increasing demands, such as increasing the speed index and the mass reduction, withstanding high loads and showing good road grip, in particular on wet roads, improving the low rolling resistance and the wear resistance and more.

The present inventors have now successfully developed an improved process for the preparation of a new generation of highly-dispersible silica, this silica having on one hand a high speed of infusion into the rubber on the initial stage of mixing, and on the other hand having a high level of dispersion in the rubber.

The inventors have found that the high dispersion of this new silica is correlated to the low durability of the silica structure and can be predicted based to the behavior of the silica particles under a specific shear stress, for example—by measuring the rate of change in the DBP absorption values from zero pressure (high silica structure) and until collapse of the silica structure at 40 MPa.

It should be noted that the DBP absorption value of the silica at this pressure (when the silica structure has collapsed) is parallel to the term CDBP absorption coefficient, often used to describe the DBP absorption value after carbon black filler destruction occurring at 165 Mpa, as measured according to the ASTM D-3493 standard method mentioned above. Hereinafter the term CDBP absorption will stand for the DBP absorption value after silica destruction at 40 MPa, and the term “modified ASTM D-3493” shall refer to the ASTM D-3493 standard test being modified to a pressure of 40 MPa.

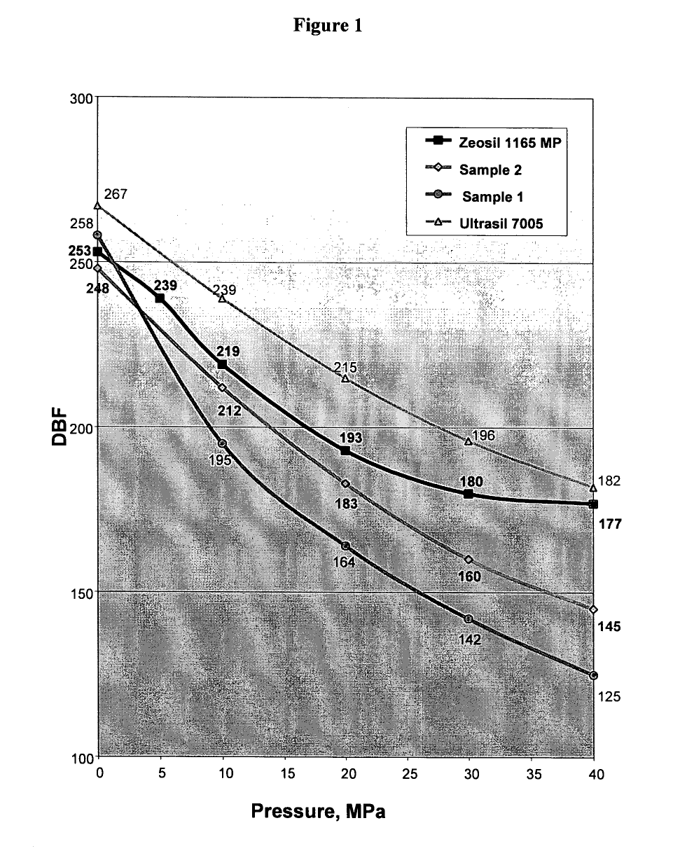

FIG. 1 is a graph showing the DBP absorption, in ml per 100 grams of silica samples, as a function of the applied pressure (MPa, from zero pressure until substantially full collapse at 40 MPa) for two preferred compositions of the invention (Samples 1 and 2), in comparison to two commercial samples (Zeosil 165MP and Ultrasil 7005).

As shown in FIG. 1, there is a clear change in DBP absorption depending on the compression value, and it is further obvious that the pattern of DBP vs. pressure of the HDS compositions of the present invention (represented by the two lowest graphs in FIG. 1), is distinct over the commercial HDS samples tested in comparison.

The lower level of this pattern signifies the easier and faster destruction of silica particles, prepared according to the present invention, during their penetration to the rubber in the mixing process and consequently, their improved dispersion into the rubber. Thus, the rate of change in the DBP absorption values of the silica of the present invention until the structural collapse thereof, reflects the higher dispersion capability of the suggested HDS of the present invention, as compared to known commercial HDS samples.

Having found this correlation, the present inventors have suggested a new coefficient termed D_{A}, which is indicative of the durability of the structure formed of the silica particles. This coefficient is calculated according to the difference in the DBP absorption between the primary uncompressed sample (DBP₀) and the sample after its compression at 40 MPa (DBP_{f} or CDBP), as shown in Formula I below:

D_{A}=1−(CDBP/DBP₀) Formula I

This coefficient theoretically ranges from 0 to 1, whereas the higher the value of the D_{A} coefficient, the weaker is the structure of the dispersed silica.

As can be seen in the Examples section below and in FIG. 1, the samples prepared according to preferred embodiments of the present invention were found to have D_{A} values of at least about 0.4, in contrast to the D_{A} of commercial silica samples which was much lower for commercial conventional silica (0.18, 0.21) and did not exceed about 0.30 for commercial HDS silica.

Thus, according to one aspect of the invention, there is provided a highly dispersible silica having a D_{A} coefficient which is substantially higher than 0.3, preferably higher than 0.35 and more preferably higher than 0.4, wherein D_{A} is as defined hereinabove, by measuring the respective DBP₀ absorption and CDBP absorption, according to the ASTM D-2414 and the modified ASTM D-3493 methods, respectively.

Even more preferably, the highly dispersible silica of the present invention has a D_{A} coefficient ranging from about 0.4 to about 0.7, more preferably ranging from about 0.4 to about 0.6.

The higher D_{A} coefficients of the silicas of the present invention reflect the weaker structure of the HDS prepared according to the preferred embodiments of the present invention, and is a good indication of its high dispersion in the rubber, since the precipitated silica particles of the HDS samples are more easily and quickly destroyed, thereby forming smaller fragments of the material, which are then readily dispersed in the rubber, having an improved rubber compatibility.

Table 1 demonstrates the relatively high correlation of the newly-defined coefficient D_{A} with the silica dispersion level in the elastomers, as determined by the electronic microscope, and with the viscosity of the rubber mixtures containing it (as determined by the Moony viscosity thereof at 100° C.).

Furthermore, as can be seen in Table 3 below, the highly dispersible silica of the present invention was further characterized by a number of additional features. Thus, the silica of the present invention may be characterized by the DA coefficient, as defined hereinabove, and in addition-by one or more of the following properties:
a) a BET specific surface area ranging from about 130 m²/gram to about 200 m²/gram, preferably ranging from about 150 m²/gram to about 220 m²/gram; and/or
b) a CTAB specific surface area ranging from about 100 to 200 m²/gram, preferably ranging from about 145 m²/gram to about 200 m²/gram; and/or
c) a BET to CTAB ratio ranging from about 1 to about 1.15, preferably ranging from about 1 to about 1.1; and/or
d) a DBP absorption of a primary uncompressed sample ranging from about 200 m1/100 grams to about 350 ml/100 grams, and/or
e) a DBP absorption of a compressed silica sample ranging from about 100 ml/100 grains to about 220 ml/100 grams.

It is well known the qualities of silica are defined by the process of its manufacturing, especially, by the features of the precipitation process.

As detailed in Example 1 and in the discussion below, the HDS of the present invention has been prepared by a specialized process devised by the inventors who have surprisingly found that:

I) the qualitative characteristics of silica are primarily defined by a correlation of volume and speed of sodium silicate introduction at the various stages of precipitation, and that

II) the silica obtained by this novel and advanced process has improved dispersion abilities, in particular when used as a filler for rubbers.

Therefore, the process for the preparation of the highly dispersible silica described herein forms another aspect of the present invention.

In particular, the inventors have found that the precipitation process should be executed as follows:

First, a diluted solution of an alkali silicate is prepared by mixing water, preferably distilled water, and an alkali silicate, and heating this solution to provide a primary solution.

Examples of possible alkali silicate include, but are not limited to sodium silicate or potassium silicate.

The most preferable alkali silicate to be used in this process is sodium silicate, Na₂O.nSiO₂, also known as “water glass” or “liquid glass”.

Preferably, the liquid glass has a SiO₂/Na₂O ratio in the range of 2.0 to 3.5, more preferably within the range of 2.3 to 3.5, yet more preferably within the range of 2.5 to 3.5. SiO₂ concentration may range between 40 to 100 grams/liter, preferably in the range of 50 to 80 grams/liter.

The alkali silicate is to be kept in a reaction vessel which is regulated to a pH ranging from about 8.0 to 10, preferably from about 8.5 to 9.8.

However, after the complete precipitation, the pH of the obtained suspension is reduced to about 4.5-6.0. The rapid reduction of the pH is achieved by feeding of carbon dioxide gas or by using corresponding amounts of stronger acids (such as sulfuric, hydrochloric, nitric etc.) as diluted solutions (concentrations under 12%).

The solution of the alkali silicate is simultaneously heated and constantly stirred until the necessary temperature of reaction is attained or until the temperature for launching the initial reaction process (55-95° C.) is reached.

This initial alkali silicate solution may also contain components from the sodium carbonate or bicarbonate alkali metal group and/or sodium hydroxides of alkali metals.

The volume of primary solution in the reactor might constitute 20% to 50% of the final precipitation volume, being determined by the concentration of the main alkali silicate solution and by the speed of its feeding into the reactor. When the prescribed parameters of the initial solution are attained, the simultaneous addition of silicate and acidifying agent, also known as an oxidizing agent, is begun, to obtain a precipitated silica suspension.

While the terms “oxidizing agent” or “acidifying agent” may include any strong mineral acid, such as sulphuric acid, azotic acid or hydrochloric acids, it is also possible to use for the purpose of the invention a number of weak organic acids, including carboxylic acids (such as acetic acid or formic acid).

Preferably, a carbonic acid is used as the acidifying agent, by the introduction of carbon dioxide (CO₂) gas.

The carbon dioxide may be added either in a concentrated form (100%) or as a mixture with air, in a ratio ranging from 40:60 CO₂:air up to 90:10 CO₂:air.

Preferably, before feeding of the CO₂ or air/gas mixture to the reaction vessel, it is heated to a temperature 30-45° C., preferably 35-40° C.

According to a preferred embodiment of the present invention, the temperature of the carbon dioxide gas or air/gas mixture, delivered to the reactor, during the first two precipitation stages (corresponding to V₁ and V₂, respectively), must be 5-10° C. higher compared to the gas temperature during the following stages.

The choice of optimal stirring conditions for carbon-dioxide precipitation is directly connected to the type and dimensions of the used reactor-stirring system.

As known in the art, silica precipitation undergoes 4 stages: nuclear formation, flocculation, aggregation and agglomeration.

It has now been found by the inventors that optimizing a specific speed and volume of the liquid glass being added during each stage, results in the formation of the improved HD silica of the present invention.

More specifically, the inventors have found that the volume of the added liquid glass should be divided between the stages, as follows:

During stage 1 (formation of precipitation nucleus) at a V₁ addition speed, 5 to 25% of the overall water glass volume should be added;

During stages 2 and 3 (flocculation and further aggregation of primary particles or “aggregate growth”) at V₂ and V₃ addition speeds, respectively, 25 to 40% of the overall water glass volume should be added; and

During stage 4 (agglomeration and particles finite form and size formation), at a V₄ addition speed, 20 to 30% of the overall water glass volume should be added.

In accordance with the present invention it was now discovered that the high dispersion silica of the present invention is obtained upon a gradual liquid glass introduction, such that the speeds of addition slowly increase: V₁<V₂≦V₃≦V₄, with the most important feature being V₁<V₂ (the subsequent speeds may be equal).

Furthermore, according to a preferred embodiment of the present invention, V₂ may sometimes be higher than V₃ as long as V₁ is smaller than V₂ and that V₃ is smaller or equal to V₄.

The absolute values of the sodium silicate infusion speed vary according to the reactor volume. For a reactor volume of 1 M³, V₁ preferably ranges from about 3.0 liters/minute to about 3.5 liters/minute; V₂ preferably ranges from about 4.0 liters/minute to about 5.0 liters/minute; V₃ preferably ranges from about 5.0 liters/minute to about 5.5 liters/minute and V₄ is preferably over about 5.5 liters/minute.

As can be seen in Example 1 below, it is not necessary to have four different rates, and in some cases it is enough to change the rate once or twice. For example, the process can have two speeds of addition, as long as the first rate is lower than the second rate (see for example, sample 2 in Table 2), corresponding to the V₁ and V₃ precipitation stages, respectively. In other cases, three different rates may be used (see for example, samples 1 and 3 in Table 2), corresponding to the V₁, V₂ and V₃ precipitation stages, respectively.

The overall duration of silica precipitation period depends on the required qualitative features of the silica and may continue for at least 75 minutes, preferably ranging from 75 minutes to 100 minutes. While the precipitation can continue without any real limitation, it is usually not required to continue beyond 120 minutes, as it will not contribute any further to the results.

It should also be noted that the duration of the entire process, as well as of each of its stages, is influenced by the ratio and content of the salts of sodium carbonate and bicarbonate, and can be determined by a person skilled in the art.

The temperature of the reaction medium can be maintained constant within the range of from about 55° C. to about 95° C., more preferably from about 65° C. to about 95° C., even more preferably from about 70° C. to about 90° C.

Furthermore, according to another preferred embodiment of the present invention, the lower level of the temperature (65° C.-80° C., preferably 65-75° C.) is allowed only during the first two stages of the precipitation.

It has now been further found by the inventors that in order to obtain a high quality HD silica, aging of the silica is preferably conducted.

As defined herein, the term “aging” refers to resting the suspension under constant stirring without introduction of any additional reagents.

Preferably, the aging is carried out at the end of the agglomeration stage at a temperature which is at least 10 to 20° C. lower than the temperature of the two last stage precipitation process.

Aging might also be conducted after the flocculation and/or aggregation stages, provided that the temperature of the next stage will be from 5° C. to 10° C. higher than during the aging stage.

Aging time may range from about 1 minute to about 120 minutes, more preferably from 5 to 120 minutes, yet more preferably from 10 to 60 minutes, and most preferably from 15 to 30 minutes.

The cooling needed for the aging stage may be achieved by using a heat exchanger.

The precipitated silica suspension obtained as described herein (with or without aging) is then filtered and optionally washed with water, to obtain a precipitated silica cake.

Filtration, combined with washing of the obtained silica cake, might be carried out on chamber or membrane press-filters, or on band or rotary filters. The cake obtained after the first washing and filtration is recovered from distilled water at 60° C. and is neutralized by a diluted acid, such as sulphuric acid up to pH in the range of 3.0 to 4.5 and then the cake is forwarded for further filtration and washing.

The content of dry solids in the final silica cake depends on the required silica qualities and constitutes about 18-24%.

The filtered and washed silica cake is then dried and is optionally granulated. Complete drying of the silica may be carried out by any number of known techniques, such as spin-flesh and spray-drying. However, spray-drying combined with further microgranulation is a preferred drying method.

The obtained granulated particles should preferably be in the range of 80-150 μm.

The newly-developed process has several distinguishing aspects over the previously-known processes, which result in the formation of the highly dispersible silica of the present invention.

In particular, the process of the present invention has the following distinguishing features:
A) The introduction of the solution of alkali metal silicate to the precipitation reactor is now conducted at varying rates, corresponding to the different stages of the precipitation process, in contrast to presently known processes which use a constant addition rate of the sodium silicate throughout the entire process, or vary the introduction rate of the sodium silicate only after “aging” periods.
In addition, the level and correlation of the speed of sodium silicate solution addition at specific process stages define the degree of silica's particles aggregation and agglomeration and ultimately define the properties of the final product (surface area, structural properties, porosity etc.).
B) The process of the present invention uses carbon dioxide (CO₂) as an acidifying agent for HDS manufacturing, while previously-known processes generally use a strong mineral acid, such as sulphuric acid, nitric acid or hydrochloric acid.
Using a weak acid ensures that the precipitation takes place in a buffer solution, thereby maintaining a constant pH level of the reaction mixture (in the range of ±0.1), even at sharp changes of the concentration of one of the components. This, in turn, enables conducting the stepped regime of the precipitation, described hereinabove, thereby regulating the aggregation and agglomeration rates of the particles on the specified stages of the carbonization and establishing optimal conditions for the development of the desired particles morphology level and structure.
C) The “aging” of the suspension is conducted at a temperature which is at least 10° C. to 20° C. lower than the temperature of the last silica precipitation stage (usually within the limits of 55° C. to 95° C.). This is in contrast to previously-known processes which use a constant temperature throughout the entire process, including during aging.

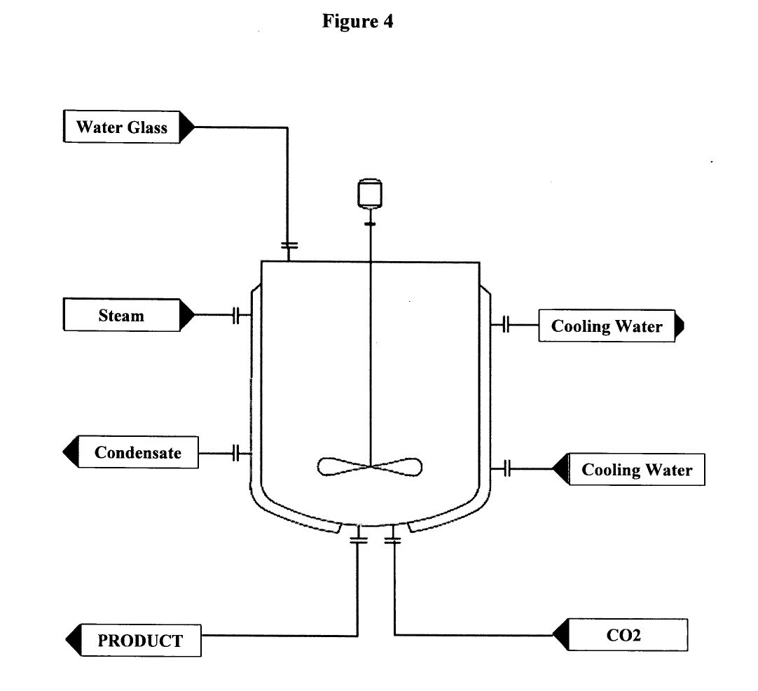

The novel and special process described herein requires a precipitation system which is specific for the requirements of the system. FIG. 4 is a scheme of the process system according to a preferred embodiment of the present invention.

Therefore, according to another aspect of the invention, there is provided a system for the preparation of highly dispersible silica, this system comprising:

A reaction vessel to which, after insertion of an initial volume of silicate solution, additional silicate solution is added simultaneously with an acidifying agent, such that the rate of addition of said silicate solution is regulated, and further wherein in this system the pH level in the vessel is maintained constant by also regulating the addition rate of the acidifying agent.

As described hereinabove, according to a preferred embodiment of the present invention, the initial volume of the silicate solution constitutes 20% to 50% of the final precipitation volume, and the rate of addition of this silicate solution is regulated such that the addition of the initial 5% to 25% of the overall silicate volume is conducted at a rate V₁ which is smaller than the rate of addition of the remaining silicate volume,

As explained hereinabove, the silica of the present invention has an appreciably higher level of dispersion in elastomers, evidence of which is the D_{A} coefficient which characterizes the silica's structure durability. Namely, after introduction of silica into the rubber, under the effect of shear stresses, occurs a significantly rapid demolition of the silica particles, their diffraction into smaller fragments and their further distribution in the elastomer matrix. Moreover, from the particles size distribution analysis after ultrasound treatment, it becomes evident that in accordance with the present invention silica particles diffract into smaller fragments as compared to reference samples of commercially available HDS.

The verification of the enhanced dispersion ability of the new silica was obtained via the analysis of rubber ultra-microtome cuts, and realized by microscope.

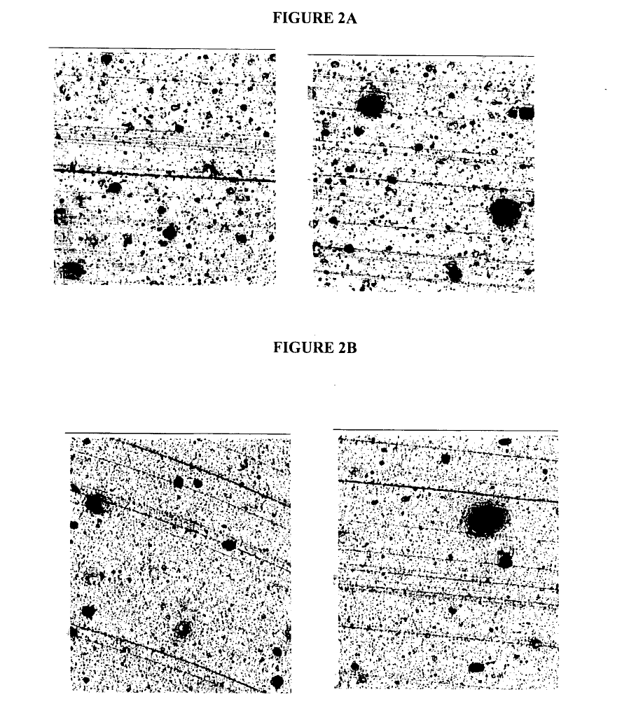

FIGS. 2A-B are pictures presenting the dispersion in rubber of silica sample 1, prepared according to preferred embodiments of the present invention (FIG. 2B), as compared to the reference HD silica Zeosil 1165MP sample (FIG. 2A).

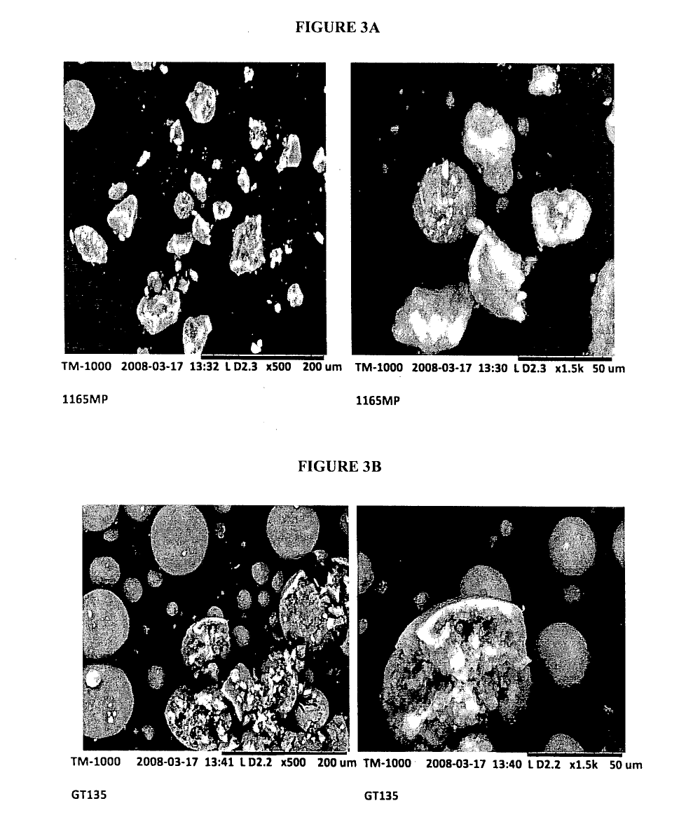

FIGS. 3A-B are pictures depicting the microgranules of silica sample 1, prepared according to preferred embodiments of the present invention (FIG. 3B), as compared to the reference HD silica Zeosil 1165MP sample (FIG. 3A).

The achieved level of dispersion in rubber of the silica prepared according to preferred embodiments of the present invention was shown to be higher compared to that of commercial HD reference samples, namely higher than 90% (see FIGS. 2A-B and 3A-B). This is indeed an evidence that the silica of the present invention could be classified as a highly dispersible silica (HDS).

Without being bound to a specific theory, the technical advantages of the silica of the present invention may be attributed to a reduced structure durability thereof, for example during mixing thereof with the rubber.

Subsequently, under the influence of shear stresses, such as during mixing, when these structures are demolished, numerous much smaller fragments or silica particles spread (dissipate) directly in the rubber matrix. The contact of silica surface with the elastomer increases and thereby the interaction of silica with elastomer through silanes is also enhanced. This leads to augmentation of the cross-linking network, and as a result, of modulus at 100 and 300% elongation in the vulcanized rubber compound. Furthermore, this also leads to a reduction in the dynamic modulus at low level deformations, evidencing a decline in particles interaction and of filler-rubber contact surface augmentation.

In another example, the present silica allows obtaining considerably lower viscosity rates (as measured according to the Moony viscosity at 100° C.), as compared with HD silica reference samples, such as Zeosil 1165 MP and Ultrasil 7005. This significantly reduces heat generation during rubber mixtures production, reduces hysteresis losses at dynamical testing. This is relevant for both powdered and microgranulated silica. Furthermore, the dispersion degree in the rubber being above 90%, and the considerably lower dynamic modulus at low level deformation (see Tables 5-7 below), indicate a reduced interaction in the filler-filler level (Payne effect). At further reprocessing of rubber mixtures the above-mentioned effect leads to an obtainment of high process parameters of rubber mixture extrusion (the extrusion speed is higher, the level of shrinkage is lower, and glossy area of the extruded article).

All this leads to superior qualities of the silica prepared in accordance with the present invention, which are expressed both in the pre-vulcanized rubber mixtures, and in the vulcanized rubber products, in comparison with the commercial HD reference silicas.

Thus, on one hand there is now provided, according to an additional aspect of the invention, rubber mixtures comprising any of the silica compositions described herein. The term “rubber mixture” as used herein means a mixture of a vulcanizable rubber and any additives required for processing it, such as fillers, vulcanizing medium, stabilizers etc.

The term “vulcanizable”, as used herein, refers to those elastomers which are sufficiently uncrosslinked to be soluble in a suitable organic solvent having a boiling point below that of water and which are capable of being crosslinked, e.g. by vulcanization, into a relatively insoluble form.

These mixtures may be characterized by a Mooney viscosity at 100° C. ranging from about 55 Mooney units to about 70 Mooney units. Alternatively, they may be characterized comparatively, in relation to the commercial HD silica Zeosil 1165MP, to have a Mooney viscosity at 100° C. being 7-15% lower than of the rubber mixtures with Zeosil 1165MP.

As shown in Example 2 and in Table 7 below, vulcanization of the rubber mixtures comprising the silica of the present invention, in comparison to reference HD silicas, was effected.

It can be seen that the kinetic parameters of vulcanization (duration of induction period, vulcanization speed, ΔM=M_{MAX}−M_{MIN}) were practically equal for the vulcanization of the reference samples.

Following the vulcanization of the rubber mixture described hereinabove, and given the properties of the silica of the present invention, there is then obtained an improved, in fact reinforced, elastomer. Indeed, rubber or elastomer reinforced with the particles of the silica of the present invention exhibited superior properties compared to rubbers reinforced by commonly known HD silicas.

Thus, there is now provided a reinforced elastomer comprising an elastomer and the highly dispersible silica particles dispersed therein. Preferably, this highly dispersible silica has a D_{A} coefficient which ranges from about 0.4 to about 0.6, being calculated as defined hereinabove.

Preferably, the elastomers suitable for the present invention are selected from styrene butadiene rubber, soluble styrene butadiene rubber, butadiene rubber, natural rubber or their any mixture or combination thereof.

As shown below, reinforced elastomers comprising particles of the HD silica of the present invention had a range of superior mechanical properties over elastomers prepared with commercial HD silica (Tables 8-10), such as higher modulus at 100% (M₁₀₀) and 300% (M₃₀₀) deformation, and as a result of that, also lower relative elongation and tensile strength. These reinforced elastomers were also distinguished by lower hardness and higher level of elasticity (see Table 8 below).

Therefore, according to yet an additional aspect of the invention, there are provided reinforced elastomers which are further characterized by one or more of the following properties:
a) a modulus 100% which is higher than 2.05 MPa;
b) a modulus 300% which is higher than 9 MPa;
c) a reinforcement index ((M300−M100)/G′ at 0.7%) which is over 23;
e) a rebound of which is higher than 31%; and
f) an elongation which is lower than 540%;

Alternatively, these reinforced elastomers may be characterized comparatively, in relation to, for example, the commercial HD silica Zeosil 1165MP.

The silica of the present invention is especially suitable for preparing reinforced elastomers to be used in the tire industry, as can be seen from the mechanical properties of tread rubbers given in Tables 8-10 below.

Thus, according to additional aspects of the invention, there is now provided a tire tread comprising an elastomer and a highly dispersible silica product as described herein.

The term “tread”, “tread rubber” or “tread tire” is used herein to designate the surface of the tread part or of the cushion tire, which is in contact with the ground during the travel of a vehicle, and is heated as a consequence of the generated frictional heat. This term is intended to include not only a conventional tire tread provided with grooves and/or lugs, but also “build-up”, which is a strip of cured rubber which does not have any tread thereon and is designed to provide a thickened surface on the tire casing prior to application of the tire tread.

Dynamical properties of tread rubbers (dynamic modulus G, loss modulus G′ and tangent delta Tg δ) were also evaluated in a wide range of temperatures (from −60° C. to 100° C.) since the measured values are known to be correlated to the performance characteristics of tread rubber for passenger automobiles, in that Tangent δ at 60° C. corresponds to the rolling resistance of the tire, G″/G′ at 0° C. corresponds to the wet grip of the tire and 1/G′ at −30° C. corresponds to the ice grip of the tire. Considering these correlations, it is evident that tread rubbers with the silica of the present invention are advantageous also in having a rolling resistance loss from 14% to 21% lower and having an ice grip from 13% to 28% higher in comparison to rubbers, containing commercial HD silica.

In particular, it was found that tire treads incorporating the HD silica prepared according to the present invention, had a rolling resistance (equivalent to tangent at 60° C.,) which was smaller than 0.1, and/or an ice grip which is larger than 0.0009.

Thus, according to yet another aspect of the invention, there is provided an elastomer composition for use in the manufacturing of a tire having a rolling resistance which is smaller than 0.1 and/or having an ice grip which is larger than 0.0009, this composition comprising a rubber and a reinforcing filler comprising the highly dispersible silica of the present invention. Preferably, this composition comprises a soluble styrene butadiene rubber, a butadiene rubber or a mixture thereof, and a reinforcing filler comprising a silica having a D_{A} coefficient as is calculated and defined hereinabove.

The term “filler” as used herein refers to a substance that is added to the elastomer to reinforce the elastomeric network. Reinforcing fillers are materials whose moduli are higher than the organic polymer of the elastomeric composition and are capable of absorbing stress from the organic polymer when the elastomer is strained.

It should be noted that the term “rolling resistance” as used herein has a close connection with the rate of fuel consumption of a running vehicle. With an increase in the rolling resistance, the friction force of vehicle tires from the road surface increases to deteriorate the rate of fuel consumption of the vehicle. Otherwise, with a lower rolling resistance, the rate of fuel consumption of the vehicle becomes higher. The rolling resistance is generally expressed in terms of a tan δ value at 60° C. The lower tan δ value represents a tire material having more excellent in rolling resistance

Thus, according to preferred embodiments of the invention, there is also provided a tire tread having a rolling resistance loss which is at least 14% lower than of the tire tread with Zeosil 1165MP, an ice grip which is at least 13% higher than of the tire tread with Zeosil 1165MP and a rebound which is at least 10% higher than of the tire tread with Zeosil 1165MP;

It should be noted that the amount of silica incorporated into the rubber, as part of the rubber mixtures may be varied, and largely depends on the intended application or use of the final product. For example, for winter tires typically up to 25% silica by weight is used (preferably from 7% to 24% silica), whereas for summer tires values are higher (typically ranging from 27 to 38%). Given the superior technological properties of the present silica, it is expected that this silica be used in even higher percentages, if the need may arise. The exact amounts can be determined by a skilled professional, depending on the exact application.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non limiting fashion.

### Materials and Analytical Methods

Materials:

Unless otherwise indicated, all chemical were obtained from common manufacturers, such as Sigma and Aldrich.

Ultrasil 7005 Silica, Sipernat 500LS, Ultrasil VN-3 and Silica-rubber coupling agent Si-69 were obtained from Degussa (Germany).

Zeosil 1165 Silica and Zeosil Premium 200 Silica are highly dispersible, amorphous precipitated silicas, which were obtained from Rhodia (France).

Sodium silicates grades “A”, “B” and “C” are manufactured by DSI by method of porcellanite leaching.

Styrene butadiene copolymer solution type Buna (VSL 5025-1) was obtained from Lanxess company.

Butadiene polymer type Europrene BR 40 was obtained from Polimeri Europe.

N-(1,3-Dimethylbutyl)-N′-phenyl-p-phenylenediamine (6PPD), Duphenyl guanidine (DPG) and N-Cyclohexyl 2-benzothiazyl sulphenamide (CBS) were obtained from Rhein Chemie Rheinau GmbH, Germany.

Zinc oxide was obtained from Arnsperger Chemikalien GmbH, Germany.

Stearic acid was obtained from Caldic Deutschland GmbH, Germany.

Sulphur was obtained from Ph Eur, BP Merck KGaA, Germany.

Instrumental Data:

BET Specific surface area was determined by low-temperature adsorption of azote (nitrogen) and was performed in accordance with ISO 5794/1 (D), using the NOVA 4000e device (Quantachrome).

CTAB specific surface area was determined in accordance with French standard NFT 45-007, using a Titroprocessor METTLER Toledo, type DL 55 and titroprocessor METTLER Toledo, type DL 70, both equipped with: pH electrode, Mettler, type DG 111 and phototrode, Mettler, type DP 550.

DBP absorption parameter of the primary un-compressed silica samples was determined in accordance with ACTM D2414 or ISO 6894. Before the test, the sample was dried at 105° C. during 2 hours.

CDBP absorption parameter of compressed silica samples was determined in accordance with the ACTM D3493 test, modified to 40 Mpa compression, instead of the customary 165 Mpa. The test is conducted either manually or automatically using a Brabender mixer. Preliminary compression of the sample was performed in the following way: 0.5-grams of silica were placed in the special press-form, shaken well for 10-15 seconds for better distribution of the material on the bottom of the form, a plunger was inserted in the press-form and all this was placed into the press, equipped with monometer. In the beginning, the sample was three times pre-pressed under minimal pressure. After that, a working pressure was established that was maintained for 30 seconds. The optimal pressure for structure demolition of silica samples, correlating with the level of dispersion in the rubber compounds was found to be 40 MPa. After the pressure was removed, the sample was withdrawn from the press-form and underwent DBP absorption tests. The granules of the samples are to be preliminary manually destructed in the mortar.

Distribution of particles size was evaluated using the laser diffraction method on the Mastersizer 2000S device (“Malvern”). The evaluation of particles size distribution was performed for both the primary sample and the sample that underwent ultrasound treatment.

Viscosity measurements were conducted in the Moony viscosimeter (manufactured by Alfa Technologies) at 100° C. and 138° C., and also in the rheometer RPA (manufactured by Alfa Technologies) at 100° C. and 160° C.

Samples were vulcanized at 155° C. and at optimal time, obtained in accordance with measurement results of vulcanization kinetics. Vulcanization experiments were conducted according to ISO-37, 1984.

The dynamic qualities of the vulcanizators (dynamic modulus G, loss modulus G′ and tangent of loss angle) were measured according to ASTM D 5992-96 in a wide range of temperatures (from about −60° C. to about 100° C.).

Rubber was manufactured with a laboratory mixer (Banbury 1.51 type), equipped with a system of automatic maintenance of a preset dump temperature.

Spray-drying was done on a Niro VSD-6.3-N spray-dryer.

### Example 1

### Preparation of high Dispersible Silica (HDS)

Into a 1 m³ volume reactor, equipped with a stirring system of propeller type and heating jet for reaching the required temperature, were introduced distilled water (220 liters) and sodium silicate (120 ml), having weight correlation of SiO₂/Na₂O, equal to 2.37 and a density of 1.106. The mixture was heated up to 90° C. while constantly stirring at 320 rpm. After the process temperature was attained, the pH level was determined to be 9.0.

Initially, the sodium silicate was introduced at a rate of 3 liters/minute, and simultaneously CO₂ (carbon dioxide, 100%) was bubbled into the reactor at a speed necessary to maintain a constant pH at around 9±0.1. As the first reaction stage was finished (after about 20 minutes, evident due to a viscosity elevation of the reaction mixture), the speed of sodium silicate addition was increased to 4 liters/minute and the speed of carbon dioxide feed was similarly increased to neutralize Na₂O and maintain the same pH level. After about 25 minutes the viscosity of the reaction mixture was reduced, and the speed of sodium silicate addition was increased up to 5.5 liters/minute. Nevertheless, the pH level was maintained at the same rate by controlling the carbon dioxide bubbling rate. Precipitation lasted about 88 minutes, resulting in a suspension, which was chilled to 70° C. and was aged for 15 minutes under constant stirring. After filtration and washing, the obtained silica cake was repulped in distilled water at 60° C. and neutralized using diluted sulphuric acid until a pH of 3.0 was attained. The cake was stirred for 10 minutes, and using ammonia water the pH level was regulated to 4.5. After that, silica suspension was filtered and washed to obtain a silica “cake” having a humidity of 80.8% at 105° C. Then silica was spray-dried and microgranulated, to obtain white microgranules of from 80 till 150 microns in size.

The comparative characteristics of the two commercial reference HDS samples (Zeosil 1165 MP and Ultrasil 7005) in relation to the silica samples of the present invention are presented in Table 1 below.

TABLE 1

| | | | | | Mooney |
|---|---|---|---|---|---|
| | DBP Absorption ml/100 gr | | | Dispersion | Viscosity |
| | Primary | | | level in | ML(1 + 4) |
| | uncompressed | Compressed | Coefficient | the rubber | at |
| Samples/Parameters | sample | sample | D_{A} | % | 100° C. |
| Reference Sample 1 | 253 | 177 | 0.30 | 91.8 | 69.2 |
| (Zeosil 1165 MP) | | | | | |
| Reference Sample 2 | 261 | 182 | 0.30 | 90.9 | 71.2 |
| (Ultrasil 7005) | | | | | |
| Sample No 1 | 258 | 125 | 0.52 | 93.4 | 61.9 |
| Sample No 2 | 250 | 145 | 0.42 | 92.8 | 64.7 |

The term “Mooney viscosity” where used herein, unless otherwise specified, may be referred to as an ML (1+4) viscosity and refers to “a viscosity of an elastomer in its uncured state, and without appreciable additives dispersed therein other than antidegradants, measured by ASTM Test Method D1646 conducted at 100° C”. Sometimes the test is referred to as ML (1+4), a shorthand for Mooney Large (using the large rotor) with a one minute static warm-up before determining the viscosity after four minutes. As used herein, a ML (1+4) viscosity measurement is intended to mean the ML(1+4) viscosity measurement.

In additional experiments, some parameters of the reaction were changed to monitor their effect on the silica qualities. The modifications and characterizations of the carbonization process of the silica samples PR1-PR3 are outlined in Table 2 below:

TABLE 2

| | | | |
|---|---|---|---|
| Silica sample | PR-1 | PR-2 | PR-3 |

Reaction Parameters

| | | | |
|---|---|---|---|
| Reactor volume m³ | 1 | 1 | 0.3 |
| sodium silicate (SC) | A, 120 ml | B, 160 ml | C, 60 ml |
| grade and quantity | | | |
| Distilled water (liters) | 220 | 220 | 70 |
| SiO₂/Na₂O | 2.37 | 2.58 | 2.98 |
| Sodium silicate density | 1.106 | 1.109 | 1.112 |
| (gr/ml) at 20° C. | | | |
| Initial sodium silicate | 90 | 80 | 88 |
| temperature (° C.) | | | |
| stirring at rpm/minute | 320 | 320 | 250 |
| (min⁻¹) | | | |
| Initial pH | 9.0 ± 0.1 | 9.5 ± 0.1 | 8.6 ± 0.1 |
| SC addition rate | 3.0/20 | 4.0/40 | 1.2/45 |
| (liters/minute)/minutes | 4.0/25 | 5.5/40 | 1.8/20 |
| | 5.5/43 | | 2.4/31 |
| Total Precipitation Time | 88 | 80 | 96 |
| (minutes) | | | |
| Suspension Chilling | 70 | 70 | 60 |
| Temperature (° C.) | | | |
| Final pH | 4.5 | 4.3 | 4.0 |
| Cake humidity | 80.8 | 77.2 | 81.9 |
| at 105° C. (%) | | | |
| Yield, kg | 30.8 | 28.4 | 7.9 |
| % | 97.8 | 96.7 | 96.3 |

The morphological parameters and structure of obtained silica samples in comparison with reference sample Zeosil MP 1165 are presented in Table 3. It is important to note that the suggested D_{A} coefficient for evaluation of dispersion level correlates with average silica particles size after ultrasound treatment, which confirms reliability of the suggested approach to evaluation of silica dispersion level in rubbers.

The term BET/CTAB in Table 3 stands for the ratio between the general surface and the outer surface. The closer is this ratio to 1, the more surface is available for contact with the rubber and hence, the higher are the strength properties.

TABLE 3

| | | | | Reference Samples | | | |
|---|---|---|---|---|---|---|---|
| | | | | | | Conventional | |
| HD Silica Samples | | | | HD silica | | silica | |
| according to the invention | | | | Zeosil | Zeosil | Sipernat | Ultrasil |
| Parameters | PR1 | PR 2 | PR 3 | 1165MP | 2000MP | 500LS | VN-3 |

| | | | | | | | |
|---|---|---|---|---|---|---|---|
| BET, m²/g | 152 | 182 | 138 | 156 | 203 | 464 | 172 |
| CTAB, m²/g | 139 | 175 | 123 | 143 | 184 | 334 | 132 |
| BET/CTAB | 1.09 | 1.04 | 1.12 | 1.09 | 1.10 | 1.39 | 1.30 |
| DBP absorption | 258 | 250 | 324 | 253 | 251 | 337 | 248 |
| (A), ml/100 g | | | | | | | |
| CDBP absorption | 125 | 145 | 143 | 177 | 173 | 276 | 196 |
| (A′), ml/100 g | | | | | | | |
| D_{A} | 0.52 | 0.42 | 0.56 | 0.30 | 0.31 | 0.18 | 0.21 |

| D(50), μm Initial | 128.2 | 82.6 | 138.3 | 121.5 | Not available | | |
|---|---|---|---|---|---|---|---|
| D(50), μm After | 4.0 | 2.5 | 4.7 | 10.4 | 6.567 | 4.896 | 16.764 |
| ultrasound | | | | | | | |

An additional sample had a D_{A} coefficient of 0.58.

### Example 2

### Compounding of HDS into Rubber

This example illustrates the utilization of silica in accordance with the present invention in typical tread rubber of ecologically friendly passenger automobiles, e.g. green tires, technological characteristics of rubber mixtures and performance characteristics of rubbers.

Rubber was prepared by combining an aromatic mineral oil-extended Styrene butadiene copolymer solution (SSBR) Buna VSL 5025-1 and polybutadiene rubber Europrene BR 40 in a ratio of 75:25, with silica (80 mass particles) and silane (6.4 mass particles), during 3 stages of mixing. The components for preparing the rubber are outlined in Table 4 below:

TABLE 4

| Components | Mass parts |
|---|---|
| Solution Styrene Butadiene | 103 |
| copolymer type Buna (SSBR) | |
| Butadiene polymer (BR) | 25 |
| Silica | 80 |
| Si - 69 | 6.4 |
| (Silica-rubber coupling agent) | |
| Zinc oxide | 3.0 |
| Stearic acid | 2.0 |
| Enerflex 65 (Aromatic oil) | 8.0 |
| N-(1,3-Dimethylbutyl)-N′- | 2.0 |
| phenyl-p-phenylenediamine | |
| (6PPD) | |
| Diphenyl guanidine (DPG) | 2.0 |
| N-Cyclohexyl 2-benzothiazyl | 1.7 |
| sulphenamide (CBS) | |
| Sulphur | 1.5 |
| Total: | 234.6 |

Especially significant for attaining the required quality of tread mixture are the first two stages of production.

During the first stage of preparation, after plasticization and homogenization of the rubbers, a graduate introduction of the entire volume of silica and silane was carried out, along with activators, antiozonants and various technological additives (Si-69, zinc oxide, stearic acid, Enerflex 65 and 6PPD). Mixing was conducted for 6 minutes at a rotor speed of 77 rpm, at a starting temperature of 50° C. at a load factor of 0.7. Dumping temperature was 150° C.-155° C. The mixing sequence is detailed below:

| At: | Stage: |
|---|---|
| 0 minutes | SSBR + BR addition |
| 1 minutes | ½ silica + Si - 69 addition |
| 2 minutes | ½ silica + oil + rest addition |
| 4-5 minutes | sweep |
| 6 minutes | dump |

During the second stage of preparation, after 16-24 hours rest, the mixture was processed without introducing any additional supplements. Mixing of the previously obtained mixture was conducted for 5 minutes at a rotor speed of 77 rpm, at a starting temperature of 50° C. at a load factor of 0.7. Dumping temperature was 150° C.

After 2 hours of resting, the third stage of preparation was conducted by roll milling the previously prepared mixture at a roll temperature of 35° C.±5° C., at a friction ratio of 1: 1.14. Mixing was conducted at a temperature of 100° C.-105° C., as follows:

| At: | Stage: |
|---|---|
| 0-1 minutes | Previous mixture addition |
| 2-4 minutes | sulphur, DPG, CBS addition |
| 5 minutes | three fine passes |

Properties of the rubber mixture, before vulcanization, using either the samples of the present invention or the reference samples are presented in Tables 5 and 6 below.

TABLE 5

| | Sample: | | | |
|---|---|---|---|---|
| | Reference | | | |
| | Sample - Zeosil | | | |
| | 1165MP | PR1 | PR2 | PR3 |
| Mooney viscosity, 100° C., | 69.2 | 61.9 | 64.7 | 60.8 |
| ML (1 + 4) | | | | |

TABLE 6

| | Reference | | | |
|---|---|---|---|---|
| RPA-Payne effect 100° C. | sample - Zeosil | | | |
| Parameter | 1165MP | PR1 | PR 2 | PR 3 |
| G′ at 0.7% strain kPa | 480 | 266 | 285 | 301 |
| Δ(G′_{0.7}-G′₉₀) kPa | 451 | 207 | 221 | 272 |

Table 6 below shows the kinetic parameters of the vulcanization process, for non-vulcanized rubber mix.

TABLE 7

| | Reference | | | |
|---|---|---|---|---|
| RPA-cure, 160° C., 0.5° arc | sample- Zeosil | | | |
| Parameter | 1165MP | PR1 | PR 2 | PR 3 |
| T_{S}, minutes | 3.70 | 3.51 | 3.57 | 3.65 |
| T₅, minutes | 1.75 | 1.92 | 2.01 | 1.98 |
| T₉₀, minutes | 11.57 | 10.58 | 11.23 | 11.48 |
| ΔM, dNm | 13.8 | 13.2 | 13.5 | 13.1 |

It can be seen that the kinetic parameters of vulcanization (duration of induction period, vulcanization speed, ΔM=M_{MAX}−M_{MIN}) were practically equal for the vulcanization of the reference samples.

The physical-mechanical properties of the vulcanized rubber are presented in Table 8 below:

TABLE 8

| | Reference | | | |
|---|---|---|---|---|
| | sample-Zeosil | | | |
| Parameter | 1165 MP | PR1 | PR 2 | PR 3 |
| Modulus 100%, MPa | 1.98 | 2.04 | 2.20 | 2.12 |
| Modulus 300%, MPa | 8.05 | 8.55 | 9.30 | 9.14 |
| Tensile strength, MPa | 18.9 | 18.0 | 17.8 | 18.0 |
| Elongation, % | 590 | 545 | 496 | 506 |
| Reinforcement index | 12.6 | 24.5 | 24.9 | 23.3 |
| (M₃₀₀ − M₁₀₀)/G′ (0.7%) | | | | |

By the term “modulus -100%” mentioned in this Example it is meant tensile stress in MPA required for a test specimen to be elongated by 100%.

By the term “modulus -300%” mentioned in this Example it is meant tensile stress in MPA required for a test specimen to be elongated by 300%.

The term “elongation” as used herein is the percentage that the material specified can stretch without breaking and may be tested in accordance with ASTM D412 or ISO 37.

The performance qualities of tire tread rubbers (abrasion resistance, rebound, dynamic modulus G, loss modulus G′ and tangent delta) were evaluated and are presented in Tables 9 and 10 below:

TABLE 9

| | Reference | | | |
|---|---|---|---|---|
| | sample-Zeosil | | | |
| Parameter | 1165 MP | PR1 | PR 2 | PR 3 |
| Hardness | 73 | 63 | 66 | 64 |
| Rebound, % | 31 | 35 | 36 | 35 |
| Abrasion resistance, mm³ | 102 | 101 | 106 | 102 |

TABLE 10

| | Reference | | | |
|---|---|---|---|---|
| | sample- Zeosil | | | |
| Parameter | 1165 MP | PR1 | PR 2 | PR 3 |
| Tangent δ, 60° C. | 0.116 | 0.102 | 0.096 | 0.092 |
| (rolling resistance) | | | | |
| G″/G′, 0° C. (wet | 2.285 | 2.168 | 2.017 | 2.123 |
| grip) | | | | |
| 1/G′ at −30° C. | 0.000847 | 0.000981 | 0.000961 | 0.000978 |
| (ice grip) | | | | |

Thus, the tread rubbers of the present invention were advantageous in having a rolling resistance loss from 14 to 21% lower and an ice grip from 13 to 28% higher in comparison with rubbers with commercial silica. The wet grip adhesion capacity and wear-resistance properties corresponded to the reference sample.

Rubber ultra-microtome cuts were also analyzed by microscope, as shown in FIGS. 2A-B and 3A-B, showing a higher level of dispersion (≧90%) in the silica of the present invention as compared to reference HDS.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A highly dispersible silica characterized by a D_{A} coefficient which ranges from 0.4 to 0.6, wherein D_{A} is calculated according to Formula I:
D_{A}=1−(CDBP/DBP₀) Formula I
wherein
DBP₀ is the dibutyl phthalate absorption of a primary uncompressed sample of said silica, as measured according to ASTM D-2441 test; and
CDBP is the dibutyl phthalate absorption after compression of said silica, as measured according to ASTM D-3493 test, said test being modified to a pressure of 40 MPa.

2. The highly dispersible silica of claim 1, further characterized by one or more of the following properties:
a) A BET specific surface area ranging from about 130 to 200 m²/gram; and/or
b) A CTAB specific surface area ranging from about 100 to 200 m²/gram; and/or
c) a BET to CTAB ratio ranging from about 1 to about 1.15; and/or
d) a DBP absorption of a primary uncompressed sample ranging from about 200 ml/100 grams to about 350 ml/100 grams; and/or
e) a DBP absorption of a compressed silica sample ranging from about 100 ml/100 grams to about 220 ml/100 grams.

3. A process of producing highly dispersible silica, said process comprising:
(a) Preparing an initial diluted silicate solution in a reaction vessel by mixing an alkali silicate with water to obtain a mixture having an initial volume of 20% to 50% of the final precipitation volume, and heating said mixture under stirring; and
(b) Precipitating silica by simultaneously adding additional alkali silicate solution and an acidifying agent to said reaction vessel, such that the rate of addition of said additional silicate solution is regulated to be:
5 to 25% of the overall silicate volume added at a rate V₁,
25 to 40% of the overall silicate volume added at a rate V₂,
25 to 40% of the overall silicate volume added at a rate V₃, and
20 to 30% of the overall silicate volume added at a rate V₄,
such that V₁ is smaller than any one of V₂, V₃ and V₄ and at least two of V₁-V₄ are different than 0 liters/minute, thereby obtaining a highly dispersible silica suspension;
(c) filtering and/or washing said precipitated highly dispersible silica suspension, thereby obtaining a precipitated silica cake.

4. The process of claim 3, wherein said silica is characterized by a D_{A} coefficient which ranges from 0.4 to 0.6, wherein D_{A} is calculated according to formula I:
D_{A}=1−(CDBP/DBP₀) Formula I
wherein DBP₀ is the dibutyl phthalate absorption of a primary uncompressed sample of said silica, as measured according to ASTM D-2441 test; and
CDBP is the dibutyl phthalate absorption after compression of said silica, as measured according to ASTM D-3493 test, said test being modified to a pressure of 40 MPa.

5. The process of claim 3, wherein V₁<V₂ and V₃≦V₄.

6. The process of claim 3, wherein said process further comprises drying and/or granulating said precipitated silica cake.

7. The process of claim 3, wherein said alkali silicate is sodium silicate.

8. The process of claim 3, wherein said acidifying agent is a carbonic acid.

9. The process of claim 8, wherein said carbonic acid is a carbon dioxide (CO₂) gas or a carbon dioxide air/gas mixture.

10. The process of claim 3, wherein an overall duration of silica precipitation is at least 75 minutes long.

11. The process of claim 3, further comprising, prior to said filtering and/or washing, aging said precipitated silica at a temperature which is at least 10° C. to 20° C. lower than the reaction temperature.

12. A system for the preparation of highly dispersible silica, said system comprising a reaction vessel to which, after insertion of an initial volume of silicate solution, additional diluted silicate solution is added simultaneously with an acidifying agent,
wherein the initial volume of said silicate solution ranges from 20% to 50% of the final volume of said solution;
further wherein the rate of addition of the initial 5% to 25% of the overall of silicate solution is conducted at a rate V₁ which is smaller than the rate of addition of the remaining silicate solution; and
further wherein the pH level in said vessel is maintained constant by regulating the addition rate of said acidifying agent.

13. The system of claim 12, wherein the highly dispersible silica prepared by said system is characterized by a D_{A} coefficient which ranges from 0.4 to 0.6, wherein D_{A} is calculated according to formula I:
D_{A}=1−(CDBP/DBP₀) Formula I
wherein DBP₀ is the dibutyl phthalate absorption of a primary uncompressed sample of said silica, as measured according to ASTM D-2441 test; and
CDBP is the dibutyl phthalate absorption after compression of said silica, as measured according to ASTM D-3493 test, said test being modified to a pressure of 40 MPa.

14. A reinforced elastomer comprising an elastomer and particles of the highly dispersible silica of claim 1.

15. The reinforced elastomer of claim 14, wherein said elastomer is selected from a styrene butadiene rubber, a soluble styrene butadiene rubber, a butadiene rubber, a natural rubber or their any mixture or combination thereof.

16. The reinforced elastomer of claim 14, characterized by at least one of the following properties:
a) a modulus 100% which is higher than 2.05 MPa;
b) a modulus 300% which is higher than 9 MPa;
c) a reinforcement index ((M₃₀₀−M₁₀₀) G′ at 0.7%) which is over 23;
d) a rebound of tread rubber being higher than 31%; and
e) an elongation which is lower than 540%.

17. A tire tread comprising an elastomer and the highly dispersible silica of claim 1.

18. The tire tread of claim 17, having a rolling resistance which is smaller than 0.1 and/or an ice grip which is larger than 0.0009.

19. A rubber mixture comprising the highly dispersible silica of claim 1.

20. The rubber mixture of claim 19, for use in the manufacturing of a tire having a rolling resistance which is smaller than 0.1 and/or an ice grip which is larger than 0.0009, said rubber mixture comprising a rubber and a reinforcing filler comprising the highly dispersible silica characterized by a D_{A} coefficient which ranges from 0.4 to 0.6, wherein D_{A} is calculated according to Formula I:
D_{A}=1−(CDBP/DBP₀) Formula I
wherein
DBP₀ is the dibutyl phthalate absorption of a primary uncompressed sample of said silica, as measured according to ASTM D-2441 test; and
CDBP is the dibutyl phthalate absorption after compression of said silica, as measured according to ASTM D-3493 test, said test being modified to a pressure of 40 MPa.
